(19) United States
(12) Patent Application Publication
(10) Pub. No.: US 2024/0356401 A1
(43) Pub. Date: Oct. 24, 2024

(54) Rotor and Electric Machine With Integrated Winding Head Cooling, Manufacturing Method and Motor Vehicle

(71) Applicant: Bayerische Motoren Werke Aktiengesellschaft, Muenchen (DE)

(72) Inventors: Markus LANG, Muenchen (DE); Robert SCHMIDT, Muenchen (DE)

(21) Appl. No.: 18/682,247

(22) PCT Filed: Sep. 6, 2022
(86) PCT No.: PCT/EP2022/074695

§ 371 Date: Feb. 8, 2024

(30) Foreign Application Priority Data
Oct. 14, 2021 (DE) 10 2021 126 696.3

(51) Int. Cl. H02K 1/32; H02K 1/24; H02K 3/18; H02K 9/19; H02K 15/02; H02K 15/06

(52) U.S. Cl. CPC H02K 1/32; H02K 1/24; H02K 3/18; H02K 9/19; H02K 15/022; H02K 15/062

(57) ABSTRACT

A rotor, a corresponding electric machine, a manufacturing method and a corresponding motor vehicle are disclosed. The rotor has a cavity structure in a first winding head supporting structure and a cut-out in a second winding head supporting structure which are connected by way of feed and return lines for a coolant. Here, the cavity structure has an inflow region, into which a coolant guide of a rotor shaft opens, and a return region which is separate from the inflow region. In this way, the rotor is configured for liquid cooling of the winding head supporting structure.

### BACKGROUND AND SUMMARY

The present invention relates to a rotor and to an electric machine fitted therewith and having an integrated cooling system, and to a method for manufacturing a rotor of this kind. The invention furthermore relates to a motor vehicle fitted with a corresponding electric machine.

Although electric machines per se have been known for a long time already, they continue to be widely used. In this context, increasingly higher requirements are placed on electric machines, e.g., in respect of higher peak and/or continuous performance, greater power density, greater reliability and robustness, simpler and more economical production, a smaller installation space requirement and/or the like. Accordingly, there remains a requirement for improvements to electric machines.

One approach for achieving a better way of cooling an electric machine is described in DE 10 2020 104 149 A1, for example. This describes a rotor for an electric machine having a rotor shaft, a carrier coupled for conjoint rotation therewith, and a squirrel cage arranged on the carrier or a winding arranged on the carrier. Here, the rotor shaft comprises a hollow space for guiding a coolant through the rotor shaft, wherein a radial shaft outer wall of the rotor shaft has at least one aperture, through which the cooling fluid can emerge from the hollow space. The aperture opens into a channel system, which comprises an annular channel and a carrier channel, which is fluidically coupled thereto and extends in the axial direction within the carrier. The annular channel extends in a ring around the rotor shaft outside the carrier and is formed jointly with the shaft outer wall and/or the carrier by a guide means arranged on the outside of the shaft outer wall. In this case, the guide means has a discharge opening, which passes radially through the guide means and via which the coolant can emerge from the channel system into the environment of the rotor.

Another approach to improving the cooling of an electric machine is described in DE 10 2015 211 048 A1. The electric machine described there has a housing and a tube, wherein the tube is in a channel. In this case, a first cooling medium can flow around the tube, and a second cooling medium can flow through the tube.

It is the object of the present invention to specify a particularly simple way of implementing effective and efficient cooling of a rotor for an electric machine.

According to the invention, this object is achieved by the subjects of the independent patent claims. Possible configurations and developments of the present invention are disclosed in the dependent patent claims, in the description and in the figures.

The rotor according to the invention is provided, i.e., configured, for an electric machine, in particular a current-excited synchronous machine (SSM). The rotor according to the invention has a laminated core, that is to say a stack comprising a multiplicity of electrical steel sheets stacked in the axial direction, and a rotor shaft surrounded thereby, at least in some section or sections. Here, the rotor shaft has a coolant guide for a coolant or cooling medium for cooling or removal of heat from the rotor during operation of the corresponding electric machine as intended. In other words, the rotor shaft is configured to guide or transfer a coolant, e.g., in a cooling circuit of the rotor or of the electric machine or from and to an external cooling circuit. Furthermore, the rotor according to the invention has a rotor winding, which forms at least one winding head on each of the axially opposite end faces of the laminated core.

Here, the axial direction corresponds to a stacking direction of the electrical steel sheets and a direction of a central rotational axis or axis of rotation of the rotor, around which the rotor rotates or can rotate in the electric machine during operation as intended. The end faces of the laminated core are the sides or faces thereof which are on the outside or external in the axial direction and are perpendicular to the axial direction, i.e., are located in a respective cross-sectional plane of the rotor.

To provide radial support for the winding heads, the rotor according to the invention furthermore has a first winding head supporting structure, which is arranged on a first end face-also referred to as the A side-of the laminated core, and a second winding head supporting structure, which is arranged on the opposite end face—also referred to as the B side—of the laminated core. In this case, at least one cavity structure, through which the coolant can flow, is formed in the first winding head supporting structure, and at least one cut-out, through which the coolant can likewise flow, is formed in or on the second winding head supporting structure.

According to the invention, it is envisaged that the at least one cavity structure of the first winding head supporting structure has a respective inflow region and a respective return flow region, which is separate from the inflow region. In this arrangement, the inflow region has an inflow opening, into which the coolant guide of the rotor shaft opens directly or indirectly, and an outflow opening for the coolant. The return flow region has a dedicated inflow opening and a dedicated outflow opening for the coolant. The coolant can thus enter or flow into the cavity structure through the inflow opening of the inflow region, while it can emerge from or flow out of the cavity structure and the rotor through the outflow opening of the return flow region.

According to the invention, it is furthermore envisaged that at least one feed line for the coolant leads in the axial direction from the outflow opening of the inflow region of the cavity structure to the opposite second winding head supporting structure. At least one return line for the coolant likewise leads in the axial direction from the second winding head supporting structure to the inflow opening of the return flow region of the cavity structure. Through the feed and return lines, the coolant can thus flow through the rotor in the axial direction in opposite directions of flow.

It is furthermore envisaged according to the invention that the respective feed line opens into the cut-out formed in or on the second winding head supporting structure, and the respective return line starts from this cut-out. In this case, the cut-out is elongate in the circumferential direction. The cut-out can thus extend at least partially around the rotor shaft, primarily or principally in the circumferential direction. For example, the cut-out can therefore have a configuration which is annular or in the form of a ring segment. In order to cool or remove heat from the second winding head supporting structure, the coolant can thus flow through the cut-out in the circumferential direction from the opening of the respective feed line to a starting point or start of the respective return line during the operation of the rotor or of the corresponding electric machine as intended.

The feed and return lines can be arranged at least substantially parallel to one another and can be offset or spaced apart from one another in the circumferential direction. In particular, the feed and return lines can be spaced apart or offset from one another in the circumferential direction at least substantially—apart from manufacturing tolerances or constraints, for example—by a length, size or extent of the respective cut-out in the circumferential direction. Thus, the opening of the feed line and the starting point of the return line can each be arranged at ends or in edge regions of the respective cut-out which are on the outside or mutually opposite when viewed in the circumferential direction. This allows maximum flow through the cut-out and can avoid or reduce formation of regions with a flow rate of the coolant in the cut-out which is virtually negligible during operation as intended.

The present invention is based on the realization that, in a rotor for an SSM, the rotor winding and, in particular, the winding heads thereof represent a significant source of heat during operation, and that robustness or endurance, in particular a continuous torque or a corresponding continuous power that can be achieved continuously or in continuous operation of the corresponding electric machine, can be improved by cooling which is more effective than conventional solutions. In the present invention, this is achieved by the fact that the coolant acting as a heat sink can flow through the winding head supporting structures by virtue of the described arrangement and configuration of the rotor, and can thus be brought or guided particularly close to the rotor winding and the winding heads thereof. As a result, a particularly short heat conduction or heat removal path, along which heat or waste heat produced during operation can be removed or dissipated from the rotor winding, can be achieved. The present invention thus makes it possible, at the same temperature or a given temperature of the rotor winding, to dissipate more heat from the rotor than is generally the case with conventional SSM rotors, or to do so more quickly. In the case of conventional SSM rotors, there may be provision, for example, for heat removal via the laminated core into the rotor shaft and then for liquid cooling of the rotor shaft. According to the present invention, in contrast, the heat does not have to be conducted through the entire laminated core but can already reach the cavity structure, the cut-out and/or the feed and return lines before this, can be absorbed during operation as intended by the coolant guided or flowing therein, and can be dissipated from the rotor by the said coolant particularly quickly, effectively and efficiently. In this case, the corresponding liquid cooling system of the rotor according to the invention is fed via the rotor shaft, which is likewise liquid-cooled by the coolant during operation as intended. Depending on the configuration, a return flow or outflow of the coolant from the rotor can likewise be achieved through or via the rotor shaft or in some other way, e.g., through the emergence or expulsion of the coolant from the rotor, in particular from the first winding head supporting structure.

The inflow and return flow regions of the first winding head supporting structure and the cut-out of the second winding head supporting structure can each have a larger diameter than the coolant guide of the rotor shaft and/or than the feed and return lines. Thus, when viewed in a respective cross-sectional plane, perpendicular to the axial direction, of the rotor, the inflow and return flow region and the cut-out can each have or occupy a larger area than the coolant guide and/or than the corresponding feed and return lines. In this way, a particularly large surface area of the cavity structure and of the cut-out can be achieved. Since this surface serves or acts as a heat transfer or heat transmission surface into the coolant for the heat produced during operation in the winding heads of the rotor winding, particularly effective and efficient cooling of or heat removal from the rotor can be achieved in this way.

In particular, the coolant guide of the rotor shaft can comprise at least one radial bore, which passes at least partially through a wall of the rotor shaft in the radial direction. Feeding the coolant through the rotor shaft can represent a particularly simple and space-saving way of supplying coolant to the rotor according to the invention, which can be implemented without impairing the electrical properties or the performance or power density of the corresponding electric machine, since the rotor shaft is located in a center of rotation, i.e., centrally or in the middle of the rotor radially.

The rotor according to the invention can have a plurality of the cavity structures described. The cavity structure can likewise comprise a number of pairs each consisting of an inflow region and a return flow region. In corresponding fashion, the rotor according to the invention can likewise have a plurality of cut-outs in or on the second winding head supporting structure. It is then also possible to provide a number of pairs each consisting of a feed line and a corresponding return line. In this case, at least one or precisely one feed line can run from each inflow region to the corresponding cut-out, and at least one or precisely one return flow line can run from the respective cut-out to the corresponding return flow region. Corresponding numbers can be determined or specified according to an available installation space, a cooling capacity required in a particular application, and/or the like.

In one possible configuration of the present invention, the feed and return lines pass through a rotor yoke of the rotor. Rotor teeth or pole shafts can extend away from the rotor yoke in the radial direction. If the rotor according to the invention is an internal rotor, the rotor yoke can form a rotor region that faces the rotor shaft. The feed and return lines are therefore arranged or formed in the region of the rotor yoke, e.g., in receptacles or bores there, and pass completely through the rotor yoke in the axial direction. At least the feed line or feed lines or also the return line or return lines can be arranged closer to the rotor winding in the radial direction than on a side of the rotor yoke which faces away from this in the radial direction. By virtue of the configuration proposed here for the present invention, particularly effective heat removal from the rotor can be achieved in a particularly space-saving manner and without or with particularly little influence on the electrical properties of the rotor or the corresponding electric machine, e.g., in comparison with an arrangement of the feed and return lines below or outside the rotor yoke or the laminated core or within the laminated core.

In another possible configuration of the present invention, the feed and return lines for the coolant form the only inflows and outflows to and from the cut-out formed in or on the second winding head supporting structure. In other words, this cut-out or the respective cut-out is fluidically connected up, that is to say, for example, integrated into a cooling circuit for the coolant, only via the respective at least one feed line and the respective at least one return line. Since therefore no other fluid guides, fluid connections or flow paths have to be implemented in or on the second winding head supporting structure or in the region or surroundings thereof, the rotor can thus be constructed in a particularly simple and compact, that is to say space-saving, manner. Moreover, it is possible in this way to reduce or limit a number of fluid-carrying connections that may have to be sealed, and this can likewise allow particularly simple configuration and particularly reliable operation of the rotor or the corresponding electric machine.

In another possible configuration of the present invention, the first winding head supporting structure is of multi-part construction. In this case, the first winding head supporting structure has an inner part resting flat against the corresponding end face of the laminated core and an outer part, which rests flat against an outer end face of the inner part, the said end face facing away from the laminated core. In this case, the cavity structure is delimited both by the inner part and by the outer part. In other words, the cavity structure is thus formed or arranged between the inner part and the outer part. The inner part and/or the outer part or parts of the cavity structure which are formed therein are thus open toward the respective other part. In this case, the inner part and/or the outer part can have corresponding depressions, which form the cavity structure, and/or can act as, possibly flat, covers for covering or closing the depressions, i.e., the cavity structure. The inner part and the outer part can each have a plate-or disk-type basic shape, that is to say can have a greater extent particularly in the radial direction, i.e. in a cross-sectional plane perpendicular to the axial direction, than in the axial direction. The configuration proposed here for the present invention allows particularly simple production of the cavity structure since corresponding depressions or hollow spaces can be open to one side in the axial direction, making it unnecessary to produce enclosed internal hollow spaces. Moreover, it is possible in this way to achieve particularly simple accessibility of the cavity structure, which may for example facilitate maintenance or repair of the rotor, e.g. cleaning of the cavity structure. At the same time, the respective surface contact between the parts of the first winding head supporting structure and with the laminated core enables the rotor to be manufactured in a particularly simple way and enables it to be particularly robust in operation.

The inner part and the outer part can be connected to one another by fastening means, being screwed, adhesively bonded, plugged in, latched and/or welded to one another, for example. The inner part can likewise be secured in a corresponding manner on the laminated core, for example.

At least one seal, in particular at least one gasket, can be arranged between the inner part and the outer part in the axial direction. This seal can thus rest against the mutually facing sides of the inner part and the outer part and, to seal the cavity structure, can surround the latter when viewed in a cross-sectional plane of the rotor. In particular, the inflow and return flow regions can each be surrounded or sealed by a dedicated, i.e., individual, seal. It is thereby possible to ensure reliable operation of the rotor or electric machine in a simple manner.

In another advantageous configuration of the present invention, the at least one cut-out formed in or on the second winding head supporting structure is delimited axially on the inside, i.e., on a side or end face facing the laminated core, by at least one sealing body resting against the corresponding end face of the laminated core. In particular, this sealing body can be secured on the laminated core, e.g., being screwed, adhesively bonded, welded and/or connected by means of a latching or plug-in connection to the said core. Axially on the outside, i.e., on a side facing away from the laminated core or the sealing body, the cut-out is delimited or enclosed and/or formed by the second winding head supporting structure or at least part of the second winding head supporting structure. The sealing body can thus be a different component than the second winding head supporting structure. In a similar way to that described elsewhere for the first winding head supporting structure, the second winding head supporting structure can likewise be of multi-part design. The sealing body can therefore then be part of the second winding head supporting structure. The parts of the second winding head supporting structure which delimit the cut-out axially on the outside can then be designed or referred to as the main part thereof, for example.

To form the cut-out, the second winding head supporting structure or the corresponding part which delimits the at least one cut-out axially toward the outside can have a depression which is annular or in the form of a ring segment. In the first case and if a plurality of mutually divided or separate cut-outs is provided in or on the second winding head supporting structure, the sealing body can have one or more projections or elevations. These can rise in the axial direction, in particular by an axial depth of the depression, above a surrounding surface or end face region of the sealing body and can be spaced apart from one another in the circumferential direction. Thus, the elevated or raised projections or elevations of the sealing body can then engage or project into the depression of the second winding head supporting structure and form barriers in some region or regions, by means of which the plurality of cut-outs is formed or spaced apart from one another in the circumferential direction. As a result, the second winding head supporting structure or the axially outer part thereof and ultimately also the at least one cut-out can be produced in a particularly simple manner. The sealing body or the axially outer end face thereof, that is to say the end face which faces away from the laminated core, can likewise be configured so as to be flat or at least substantially level and can act as a cover or covering for the at least one depression. In order to form a plurality of mutually divided or separate cut-outs, a plurality of depressions spaced apart from one another in the circumferential direction can then be formed in a corresponding manner in the second winding head supporting structure or the corresponding part of the second winding head supporting structure. In either case, the at least one cut-out can be sealed fluid-tightly by at least one seal, in particular against fluid escaping in the radial direction from or at the second winding head supporting structure. The configurations of the present invention which are proposed here can allow particularly simple manufacture and particularly robust construction and operation and possibly simplified serviceability of the rotor.

In another possible configuration of the present invention, the rotor has a plurality of rotor poles arranged in a manner distributed, in particular uniformly, in the circumferential direction. For example, each rotor pole can have a corresponding pole leg or be formed by such a pole leg. At least for each pair of rotor poles, the first winding head supporting structure has at least one or precisely one inflow region and at least one or precisely one return flow region. At least for each pair of rotor poles, the second winding head supporting structure has at least one or precisely one cut-out. In this case, the cut-outs extend at least or at least substantially over the entire extent of a pole shaft of at least one of the rotor poles in the circumferential direction. For example, the respective cut-out can extend at least as far as a diameter of the associated feed and return lines over the width or extent of the pole shaft in the circumferential direction or, for example, can extend beyond this by the diameters of the feed and return lines. Likewise, the respective feed and return lines connected fluidically in a direct manner to the same cut-out can be spaced apart further in the circumferential direction than the extent or width of the respective pole shaft, and thus the respective cut-out can extend correspondingly far in the circumferential direction. For example, a total of precisely three or at least three feed lines and, correspondingly, precisely three or at least three return lines can be provided for six rotor poles of the rotor, and these lines are arranged alternately and distributed uniformly or at regular intervals in the circumferential direction. Depending on the installation space available and the cooling requirement in the respective application, it is likewise possible to provide different numbers of feed and return lines, e.g., at least one feed line and one return line per rotor pole. In each case one pair of an inflow and return flow region of the cavity structure of the first winding head supporting structure can extend in the circumferential direction at least substantially over the region occupied by the associated cut-out, that is to say the cut-out fluidically connected therewith by the corresponding feed and return lines. By means of the configuration proposed here for the present invention, particularly effective cooling of or heat removal from the rotor can be achieved since the heat which arises during operation in the respective rotor winding wound around the pole shaft can be dissipated into the coolant over a particularly short distance at every location.

In another possible configuration of the present invention, the outflow opening or a further outflow of the at least one return flow region of the cavity structure of the first winding head supporting structure is open radially to the outside. Thus, it is possible to provide a correspondingly radially extending portion, a radial bore or the like, with the result that, when the rotor rotates around the axial direction, i.e., the central axis of rotation of the rotor, in particular during the normal operation of the corresponding electric machine, the coolant, after having flowed into the return flow region from the return line, emerges from or is or can be flung out of the first winding head supporting structure through the radially outwardly open outflow opening or the radially outwardly open further outflow under the action of rotation or centrifugal force. This enables the coolant to emerge or be flung out, in particular also out of the rotor overall. Thus, after having been fed into the rotor via the rotor shaft or along the rotor shaft, and having flowed through the first winding head supporting structure, the at least one feed line, the second winding head supporting structure and the at least one return line back to the first winding head supporting structure, the coolant can therefore be used to cool other components of the electric machine, e.g., a stator or the like surrounding the rotor in the correct installation position. Ultimately, this allows a particularly simple construction of the rotor or the coolant guide since, for example, it is possible to dispense with a corresponding return of the coolant through the rotor shaft and with sealing at the outflow opening or the further outflow of the return flow region.

Another aspect of the present invention is a method for manufacturing a rotor according to the invention. In one method step of the method according to the invention, a multiplicity of electrical steel sheets is arranged to form the laminated core, i.e. stacked. In a further method step, the feed and return lines are introduced into corresponding axial receptacles, in particular bores or stamped features, of the laminated core or electrical steel sheets. In this case, the feed and return lines can be inserted or pushed into these receptacles, in particular in the axial direction. During, before or after this process, electrical slot insulators can also be arranged or mounted on the laminated core.

In a further method step, the first winding head supporting structure and the second winding head supporting structure are arranged or mounted on the end faces of the laminated core. In this case, first the inner part and then the outer part, which together form the cavity structure of the first winding head supporting structure, can be arranged on one end face, and first the sealing body and then the second winding head supporting structure or the axially outer part thereof, which together form the at least one cut-out, can be arranged on the other end face. Here, these component parts can also be secured, e.g. to one another and/or to the laminated core. It is likewise possible for the winding head supporting structures initially to be fully preassembled separately from the laminated core. In this case, it is possible, in particular, for the inner part and the outer part of the first winding head supporting structure to be connected to one another and/or for the sealing body to be secured on the second winding head supporting structure or the main part thereof. The first and/or second winding head supporting structure preassembled in this way can then be secured or mounted as in each case a multi-part component element on the laminated core, e.g., can be slipped over the latter or a corresponding receptacle or holder or the like, in particular in the axial direction. This can allow particularly simple, efficient and low-cost manufacture or final assembly of the rotor and/or can simplify a logistics system for the manufacture of the rotor.

Furthermore, it is also possible here, for example, for supporting structure insulators for electrically insulating the winding head supporting structures to be attached or to be preassembled as parts of the winding head supporting structures.

In a further method step, the laminated core is wound with the at least one rotor winding. In a further method step, the rotor shaft is fitted into a central shaft receiving space of the laminated core.

In further method steps, which may be optional, depending on the configuration of the rotor, covering slides for covering the rotor winding or slots of the laminated core or else for holding the rotor winding, support rings, end caps on the end faces, coverings and/or housing parts and/or the like can be fitted, remaining free spaces or hollow spaces within the rotor can be filled with an electrically insulating potting compound, and/or the like. To manufacture the corresponding electric machine, the rotor manufactured in this way can then be arranged or mounted in a corresponding stator. Further sequences or measures mentioned in connection with the other aspects of the present invention can form further, possibly optional, method steps of the method according to the invention. The method according to the invention allows particularly simple, low-cost and flexibly adaptable manufacture of the rotor according to the invention.

Another aspect of the present invention is an electric machine, in particular an SSM, which has a stator and the rotor according to the invention or manufactured by the method according to the invention, which is arranged in such a way as to be spaced apart from the latter by an air gap, and is mounted so as to be rotatable relative to the stator about a central axis of rotation. In particular, the electric machine according to the invention can be or correspond to the electric machine mentioned in connection with the other aspects of the present invention. Accordingly, the electric machine according to the invention can have some or all of the characteristics and/or features mentioned in these contexts.

Another aspect of the present invention is a motor vehicle which has the or an electric machine according to the invention, in particular as a traction machine. The motor vehicle according to the invention represents a particularly favorable application for the electric machine according to the invention since, during the operation of the motor vehicle, very different load requirements or loads on the electric machine, in particular also brief or continuous peak loads, may occur dynamically, and the improved cooling according to the invention may thus directly support the corresponding operation of the motor vehicle. At the same time, the particularly effective and efficient cooling of the rotor makes it possible to save weight in comparison with other solutions, and this can have a direct positive effect on a response behavior or driving behavior and on a range of the motor vehicle.

Further features of the invention can be found in the claims, the figures and the description of the figures. The features and combinations of features mentioned above in the description and the features and combinations of features indicated below in the description of the figures and/or only in the figures can be used not only in the respectively specified combination but also in other combinations or in isolation without exceeding the scope of the invention.

### BRIEF DESCRIPTION OF THE DRAWINGS

FIG. 1 shows a schematic longitudinally sectioned perspective illustration of a segment of a rotor;

FIG. 2 shows a schematic first perspective detail illustration of a number of parts of a first winding head supporting structure of the rotor;

FIG. 3 shows a schematic second perspective detail illustration of the number of parts of the first winding head supporting structure;

FIG. 4 shows a schematic perspective detail illustration of a second winding head supporting structure of the rotor and of a corresponding sealing body;

FIG. 5 shows a schematic longitudinally sectioned perspective detail illustration of the rotor in an intermediate state of manufacture;

FIG. 6 shows a schematic partially transparent perspective detail illustration of the rotor intended to illustrate a coolant guide on the side of the first winding head supporting structure; and

FIG. 7 shows a schematic partially transparent perspective detail illustration of the rotor intended to illustrate a coolant guide on the side of the second winding head supporting structure.

### DETAILED DESCRIPTION OF THE DRAWINGS

In the figures, identical and functionally identical elements are provided with the same reference signs.

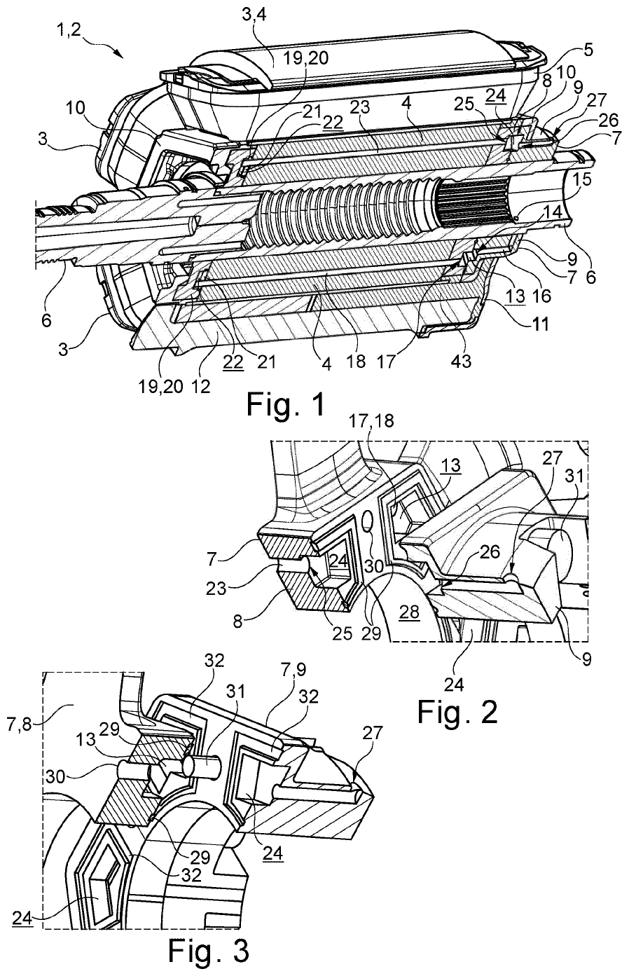

FIG. 1 shows a schematic longitudinally sectioned perspective illustration of a segment of an electric machine 1, in particular a rotor 2. The rotor 2 has a plurality of rotor poles 3. These are formed by a correspondingly shaped laminated core 4 and a rotor winding 5 wound around the said core. Here, a winding wire of the rotor winding 5 is covered by a winding insulator and is therefore not visible in detail.

The laminated core 4 surrounds a rotor shaft 6, which extends centrally in the axial direction through the laminated core 4. The rotor shaft 6 can be part of the rotor 2 or of the electric machine 1.

At the two axially opposite end faces of the laminated core 4, the rotor winding 5 forms winding heads, which are held or supported by a respective winding head supporting structure. Here, a first winding head supporting structure 7 arranged on one of the end faces is of multi-part design and comprises an inner part 8, which rests against the corresponding end face of the laminated core 4, and an outer part 9 arranged axially on the outside thereof. In this case, the winding head supporting structures are covered by respective supporting structure insulators 10, at least in some region or regions or in part.

Also illustrated here, are regions or segments of an outer cover 11 and a slot wedge 12 of the rotor 2. Free spaces that remain between the said components can be filled or sealed with a potting material 43, which is likewise illustrated here only in certain regions or segments for the sake of greater clarity.

In the present case, the rotor 2 is designed for liquid cooling. For this purpose, a cavity structure is formed in the first winding head supporting structure 7. This comprises an inflow region 13, which has an inflow opening 14. A coolant, in particular a liquid coolant, can flow into the cavity structure via this inflow opening 14. The liquid cooling system of the rotor 2 is fed via the rotor shaft 6. For this purpose, the rotor shaft 6 has at least one radial bore 15, in particular precisely one radial bore for each inflow region 13. Through this radial bore 15, coolant guided in the rotor shaft 6 can flow through an adjoining coolant guide 16 into the inflow region 13.

The inflow region 13 has an outflow opening 17, adjoining which is a feed line 18. The feed line 18 extends in the axial direction through the laminated core 4, in particular through a rotor yoke of the laminated core 4, as far as a second winding head supporting structure 19, which is arranged on the other end face of the laminated core 4.

Here, the second winding head supporting structure 19 comprises a main part 20. Arranged axially on the inside thereof, on the corresponding end face of the laminated core 4, is a sealing body 21. The main part 20 and the sealing body 21 jointly form or delimit at least one cut-out 22. One end of the respective feed line 18 opens into this cut-out 22. The coolant can thus flow into the cut-out 22 in the axial direction through the feed line 18 and can then flow through the cut-out 22 in the circumferential direction.

Here, a plurality of such cut-outs 22, e.g. one cut-out 22 for each pair of rotor poles 3, can be formed in the circumferential direction. At least one or precisely one associated feed line 18 can open into each of these cut-outs 22. Moreover, at least one or precisely one associated return line 23 starts from each of these cut-outs 22. Thanks to the sectional illustration of the rotor 2 which is chosen here, it is possible to see such a return line 23 for a cut-out 22 other than that for the feed line 18.

The return line 23 passes through the laminated core 4 in the axial direction, in particular likewise passing through the rotor yoke of the said core, as far as the first winding head supporting structure 7. There, the return line 23 opens into a respective return flow region 24 of the cavity structure of the first winding head supporting structure 7. For this purpose, the return flow region 24 has a corresponding inflow 25. The coolant can then drain or flow out of the return flow region 24 through an outflow 26. For example, the coolant can be guided to a coolant return and can be, for example, once again passed through the rotor shaft 6 and optionally further regions, stations or components, e.g., of an external cooling circuit or the like, back to the radial bore 15. In the example under consideration, however, the coolant can flow through the outflow 26 to a spray opening 27. Here, by way of example, this spray opening 27 is formed in the outer part 9 of the first winding head supporting structure 7 and is open radially outward. Thus, the coolant can be sprayed or can emerge out of the spray opening 27 during the operation of the electric machine 1, i.e., during rotation of the rotor 2, and can then wet other component parts or components of the electric machine 1 for the purpose of cooling, for example.

For additional illustration, FIG. 2 shows a schematic partially exploded perspective detail illustration of the first winding head supporting structure 7. Here, the inner part 8 and the outer part 9 thereof are shown as being spaced apart from one another in the axial direction. As a result, the inflow region 13 and the corresponding return flow region 24, which is separate therefrom, that is to say spaced apart or divided therefrom in the circumferential direction, for one of the rotor poles 3 or a corresponding pole leg of the rotor 2 are visible as recesses or depressions in the inner part 8.

In order to avoid repetitions, it is in particular details that are new with respect to each of the previously described figures which are explored below, and component parts that have already been described are not described again.

By virtue of the partially exploded illustration, cavity seals 29 arranged between the inner part 8 and the outer part 9 can be seen here. These cavity seals 29 each surround a region of the cavity structure of the first winding head supporting structure 7. In this case, a respective individual cavity seal 29 is arranged around each of the inflow regions 13 and around the return flow regions 24.

To fasten the outer part 9 on the inner part 8 and/or on the laminated core 4, the inner part 8 has corresponding fastening holes 30. These can be plug-in or screw holes or the like, for example. A respective fastening element 31 can engage in the axial direction in the fastening holes 30, that is to say, for example, can be screwed in in the form of a screw. The fastening holes 30 can each be arranged, for example, between an inflow region 13 and a return flow region 24 that is adjacent in the circumferential direction. Corresponding to this, the outer part 9 can also have corresponding holes, apertures or passages.

Here, a second return flow region 24 is partially visible, illustrating the fact that the cavity structure here comprises a plurality of inflow regions 13 and return flow regions 24 arranged in the circumferential direction, in particular uniformly or in a regular manner, around a central rotor shaft leadthrough 28. As a result, correspondingly uniform removal of heat from the rotor 2 can be achieved, and asymmetry or unbalance of the rotor 2 can be avoided or reduced.

Similarly to FIG. 2, FIG. 3 shows a schematic partially exploded perspective detail illustration of the first winding head supporting structure 7. Here, however, the direction of view or perspective shown is different, in which an end face of the outer part 9 facing the inner part 8 is partially visible. From this, it can be seen that, to form the cavity structure, depressions are also formed in the outer part 9 as parts of the outflow regions 13 and of the return flow regions 24, and these are open in the axial direction toward the inner part 8. In this case, the corresponding depressions are surrounded by a respective seal receptacle 32 for receiving the cavity seal 29, in particular both on the side of the inner part 8 and on the side of the outer part 9. This can enable the mutually facing sides or end faces of the inner part 8 and of the outer part 9 to rest flat against one another.

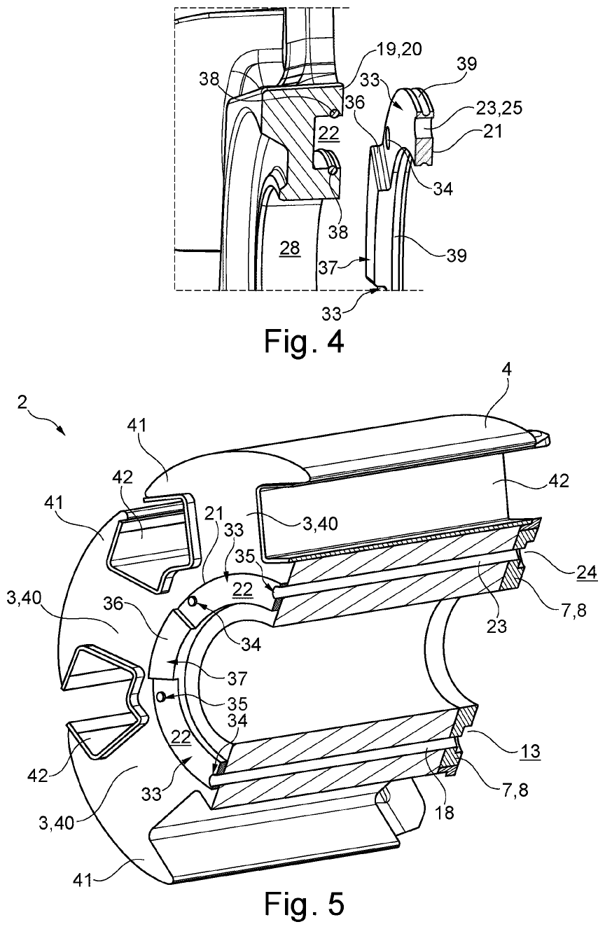

Similarly to FIG. 2 and FIG. 3, FIG. 4 shows a schematic partially exploded perspective detail illustration. Here, the second winding head supporting structure 19 or the main part 20 thereof and, spaced apart therefrom, the sealing body 21 are illustrated. For the formation of the cut-outs 22, the main part 20 has an annular depression, which annularly surrounds a rotor shaft leadthrough 28 of the second winding head supporting structure 19. Axially on the inside, the cut-outs 22 are covered or delimited by a respective region of a cut-out inner side 33, which is formed by a corresponding region of an outer end face of the sealing body 21. Radial passages are formed in the cut-out inner side 33, and these act as a feed line opening 34 for the respective feed line 18 and respectively as a return line starting point 35 for the respective return line 23. Between the corresponding regions of the cut-out inner side 33, the sealing body 21 has respective elevations 36, which are raised outward in the axial direction, i.e. in the direction of the main part 20, above the cut-out inner side 33. The elevations 36 can each pass through or fill the annular depression formed in the main part 20 completely in the axial direction. In this way, therefore, elevation end faces 37 of the elevations 36 that face the main part 20 can rest against an inner end face of the annular depression. The annular depression is thereby divided into the plurality of cut-outs 22 in the circumferential direction.

For the sealing of the depression or of the cut-outs 22, ring seals 38 are provided here, these being arranged on radial inner and outer sides of the annular depression. Corresponding to this, the sealing body 21 has respective annular seal grooves 39 radially on the inside and radially on the outside, in which the respective ring seal 38 engages in the correct installation position.

For greater clarity, FIG. 5 shows a schematic longitudinally sectioned perspective detail illustration of the rotor 2 in an intermediate state of manufacture. Here it can be seen that the rotor 2 is designed as a salient-pole rotor. In this case, by way of example, the rotor 2 here has one pole shaft 40 for each rotor pole 3, the said shaft having a pole shoe 41 adjoining it radially on the outside. Intermediate rotor slots are each lined with a slot insulator 42, which rests against the laminated core 4 and serves to electrically insulate the laminated core 4 from the rotor winding 5.

It can furthermore be seen that each of the cut-outs 22 has a feed line opening 34 for the respective feed line 18 and a return line starting point 35 for the respective return line 23. In this case, the respective feed line opening 34 and the respective return line starting point 35 are arranged in edge regions of the respective cut-out 22 in the circumferential direction. The cuts-outs 22 each extend in the circumferential direction at least over the entire extent of one pole shaft 40 or rotor pole 3.

In particular, a feed line 18 or a return line 23 can each be arranged centrally between two adjacent rotor poles 3 or rotor shafts 40 in the circumferential direction. When considered in the circumferential direction, one cut-out 22 and one elevation 36 in each case can be arranged alternately in the region of the pole shafts 40. In other words, therefore, in the circumferential direction, a respective cut-out 22 is arranged on or radially on the inside of or below each second pole shaft 40, and a respective elevation 36 is arranged on or radially on the inside of or below each of the other pole shafts 40.

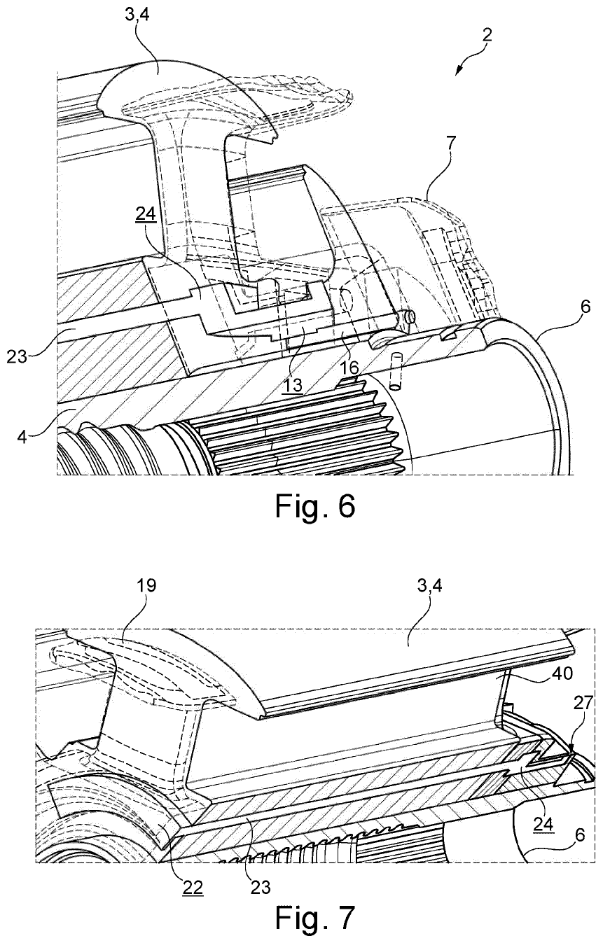

FIG. 6 shows a schematic partially transparent perspective detail illustration of the rotor 2 intended to further illustrate a guide for the coolant, in particular on the side of the first winding head supporting structure 7. Here it can be seen that the coolant can flow out of the rotor shaft 6 through the coolant guide 16 into the respective inflow region 13, and can flow in the opposite direction of flow through the return line 23 into the respective return flow region 24.

FIG. 7 shows a schematic partially transparent perspective detail illustration of the rotor 2 intended to further illustrate a guide for the coolant on the side of the second winding head supporting structure 19. Once again, it can be seen here that the cut-outs 22 each extend in such a way as to curve in the form of an annular segment in the circumferential direction in the region of each rotor pole 3 or pole shaft 40.

Overall, the examples described show how selective cooling of a supporting structure for winding heads of an SSM rotor can be implemented in order to achieve particularly effective and efficient rotor heat dissipation.

### LIST OF REFERENCE SIGNS

1 electric machine
2 rotor
3 rotor pole
4 laminated core
5 rotor winding
6 rotor shaft
7 first winding head supporting structure
8 inner part
9 outer part
10 supporting structure insulator
11 outer cover
12 slot wedge
13 inflow region
14 inflow opening
15 radial bore
16 coolant guide
17 outflow opening
18 feed line
19 second winding head supporting structure
20 main part
21 sealing body
22 cut-out
23 return line
24 return flow region
25 inflow
26 outflow
27 spray opening
28 rotor shaft leadthrough
29 cavity seal
30 fastening hole
31 fastening element
32 seal receptacle
33 cut-out inner side
34 feed line opening
35 return line starting point
36 elevation
37 elevation end face
38 ring seal
39 seal groove
40 pole shaft
41 pole shoe
42 slot insulator
43 potting material

1-10. (canceled)

11. A rotor for an electric machine, the rotor comprising:
a laminated core;
a rotor shaft surrounded by the laminated core and having a coolant guide;
a rotor winding, which forms respective winding heads at axially opposite end faces of the laminated core; and
a first winding head supporting structure having a cavity structure formed therein, through which the coolant can flow in order to cool the first winding head supporting structure, and a second winding head supporting structure, which are arranged on the end faces of the laminated core in order to provide radial support for the winding heads;
wherein the cavity structure has an inflow region including an inflow opening, into which the coolant guide of the rotor shaft opens, and having an outflow opening and a return flow region, which is separate from the inflow region and has a dedicated inflow opening and a dedicated outflow opening;
a feed line for the coolant leads in an axial direction from the outflow opening of the inflow region to the second winding head supporting structure, and a return line for the coolant leads in the axial direction from the second winding head supporting structure to the inflow opening of the return flow region; and
a first cut-out, into which the feed line opens and from which the return line starts and which is elongate in the circumferential direction is formed in or on the second winding head supporting structure, thus enabling the coolant to flow through the cut-out in the circumferential direction from the feed line to the return line in order to cool the second winding head supporting structure.

12. The rotor according to claim 11, wherein the feed line and the return line pass through a rotor yoke of the rotor.

13. The rotor according to claim 11, wherein the feed line and the return line for the coolant form the only inflows and outflows of the cut-out formed in or on the second winding head supporting structure.

14. The rotor according to claim 12, wherein the feed line and the return line for the coolant form the only inflows and outflows of the cut-out formed in or on the second winding head supporting structure.

15. The rotor according to claim 11, wherein the first winding head supporting structure is of multi-part construction and has an inner part resting flat against the end face of the laminated core and an outer part, which rests flat against an outer end face of the inner part, the end face facing away from the laminated core, wherein the cavity structure is delimited both by the inner part and by the outer part.

16. The rotor according to claim 12, wherein the first winding head supporting structure is of multi-part construction and has an inner part resting flat against the end face of the laminated core and an outer part, which rests flat against an outer end face of the inner part, the end face facing away from the laminated core, wherein the cavity structure is delimited both by the inner part and by the outer part.

17. The rotor according claim 11, wherein the cut-out formed in or on the second winding head supporting structure is delimited axially on the inside by a sealing body resting against the end face of the laminated core, and axially on the outside by a part of the second winding head supporting structure.

18. The rotor according claim 12, wherein the cut-out formed in or on the second winding head supporting structure is delimited axially on the inside by a sealing body resting against the end face of the laminated core, and axially on the outside by a part of the second winding head supporting structure.

19. The rotor according to claim 11, wherein the rotor has a plurality of rotor poles arranged in a manner distributed in the circumferential direction and, at least for each pair of rotor poles, the first winding head supporting structure has an inflow region and a return flow region, and the second winding head supporting structure has a second cut-out, wherein the second cut-outs extend in the circumferential direction at least or at least substantially over the entire extent of a pole shaft of at least one rotor pole.

20. The rotor according to claim 12, wherein the rotor has a plurality of rotor poles arranged in a manner distributed in the circumferential direction and, at least for each pair of rotor poles, the first winding head supporting structure has an inflow region and a return flow region, and the second winding head supporting structure has a second cut-out, wherein the second cut-outs extend in the circumferential direction at least or at least substantially over the entire extent of a pole shaft of at least one rotor pole.

21. The rotor according to claim 11, wherein the outflow opening or a further outflow of the return flow region is open radially to the outside, such that when the rotor rotates around the axial direction, the coolant, after having flowed into the return flow region from the return line, emerges from the first winding head supporting structure through the radially outwardly open outflow opening or the radially outwardly open further outflow under the action of centrifugal force.

22. The rotor according to claim 12, wherein the outflow opening or a further outflow of the return flow region is open radially to the outside, such that when the rotor rotates around the axial direction, the coolant, after having flowed into the return flow region from the return line, emerges from the first winding head supporting structure through the radially outwardly open outflow opening or the radially outwardly open further outflow under the action of centrifugal force.

23. A method for manufacturing a rotor for an electric machine, the rotor including a laminated core; a rotor shaft surrounded by the laminated core and having a coolant guide; a rotor winding, which forms respective winding heads at axially opposite end faces of the laminated core; and a first winding head supporting structure having a cavity structure formed therein, through which the coolant can flow in order to cool the first winding head supporting structure, and a second winding head supporting structure, which are arranged on the end faces of the laminated core in order to provide radial support for the winding heads; wherein the cavity structure has an inflow region including an inflow opening, into which the coolant guide of the rotor shaft opens, and having an outflow opening and a return flow region, which is separate from the inflow region and has a dedicated inflow opening and a dedicated outflow opening; a feed line for the coolant leads in the axial direction from the outflow opening of the inflow region to the second winding head supporting structure, and a return line for the coolant leads in the axial direction from the second winding head supporting structure to the inflow opening of the return flow region; and a cut-out, into which the feed line opens and from which the return line starts and which is elongate in the circumferential direction is formed in or on the second winding head supporting structure, thus enabling the coolant to flow through the cut-out in the circumferential direction from the feed line to the return line in order to cool the second winding head supporting structure, the method comprising:
arranging a plurality of electrical steel sheets to form the laminated core;
introducing the feed and return lines into corresponding axial receptacles of the laminated core;
arranging the first winding head supporting structure and the second winding head supporting structure on the end faces of the laminated core, wherein, in each case successively or as preassembled multi-part winding head supporting structures, an inner part and an outer part, which together form the cavity structure of the first winding head supporting structure, are arranged on one end face, and a sealing body and the second winding head supporting structure, which together form the cut-out, are arranged on the other end face;
winding the laminated core with the rotor winding; and
fitting the rotor shaft into a central shaft receiving space of the laminated core.

24. An electric machine comprising a stator and a rotor according to claim 11, wherein the rotor is spaced apart from the stator by an air gap and is mounted so as to be rotatable relative to the stator about a central axis of rotation.

25. A motor vehicle having an electric machine according to claim 24, wherein the electric machine is a traction machine.
